(19) United States
(12) Patent Application Publication
(10) Pub. No.: US 2016/0226428 A1
(43) Pub. Date: Aug. 4, 2016

(54) System and Method for Controlling Wound Rotor Synchronous Motor

(71) Applicant: Hyundai Motor Company, Seoul (KR)

(72) Inventor: Young Jun KIM, Suwon-si (KR)

(73) Assignee: Hyundai Motor Company

(21) Appl. No.: 14/924,478

(22) Filed: Oct. 27, 2015

(30) Foreign Application Priority Data
Feb. 3, 2015 (KR) 10-2015-0016474

(51) Int. Cl. H02P 29/00; H02P 6/00

(52) U.S. Cl. CPC H02P 29/0044; H02P 6/002

(57) ABSTRACT

The present invention relates to a system and a method for controlling a wound rotor synchronous motor, and more particularly, to a system and a method for controlling a wound rotor synchronous motor that increase a rated operating time of the wound rotor synchronous motor without an output limit of a motor when an overtemperature is generated in a rotor.

That is, the present disclosure provides a system and a method for controlling a wound rotor synchronous motor which configure a current command map by a dualized map which is switchable according to a purpose to selectively use the current command map according to an operating condition to increase a rated operating time of the wound rotor synchronous motor without an output limit of a motor when an over temperature of a rotor is generated.

### CROSS-REFERENCE TO RELATED APPLICATION

This application claims the benefit of Korean Patent Application No. 10-2015-0016474 filed on Feb. 3, 2015, which is hereby incorporated by reference.

### FIELD

The present disclosure relates to a system and a method for controlling a wound rotor synchronous motor, and more particularly, to a system and a method for controlling a wound rotor synchronous motor that increase a rated operating time of the wound rotor synchronous motor without an output limit of a motor when an overtemparature is generated in a rotor.

### BACKGROUND

The statements in this section merely provide background information related to the present disclosure and may not constitute prior art.

Eco-friendly vehicles such as a hybrid vehicle and an electric vehicle as vehicles driven by using a drive motor as a power source have drive modes such as an electric vehicle (EV) mode which is a pure electric vehicle mode using only power of the drive motor and a hybrid electric vehicle (HEV) using rotary force of both an engine and the drive motor as the power.

As the drive motor adopted as a driving power source of the eco-friendly vehicle, a permanent magnet type synchronous motor is primarily used, but rare earth (Nd, Dy) metal for manufacturing a permanent magnet, and the like are limitedly lied in some countries. Thus, research and development for a wound rotor synchronous motor (WRSM) which may substitute for the permanent magnet type synchronous motor is in progress by considering that the rare earth metal is very expensive.

A rotor of the wound rotor synchronous motor has a structure in which an epoxy molding material is charged between coils and an end coil cover that is attached between both ends of the rotor.

However, the wound rotor synchronous motor has an advantage in that since the rotor coil is sealed by the epoxy molding material and the end coil cover, heat (iron loss+copper loss) generated by the rotor is not easily emitted to the outside, and as a result, the temperature of the rotor significantly increases.

Therefore, as a method for cooling the rotor, since the rotor is a rotation body, a direct cooling scheme (for example, water cooling, and the like) using a cooling medium cannot be adopted and an indirect cooling scheme that cools the rotor by heat transfer (heat exchange) by forming a cooling path in a current stator housing and supplying cooling water is adopted.

Nevertheless, since the wound rotor synchronous motor has a disadvantage in that the wound rotor synchronous motor is manufactured in a structure in which the coil is wound on a rotor core unlike the permanent magnet type synchronous motor, the copper loss by conduction of direct current (DC) field current is added to the rotor core iron loss, and as a result, the temperature of the rotor significantly increases and the output limit due to the overtemparature of the rotor frequently occurs in an operating area having larger DC field current.

The output limit due to the overtemparature of the rotor may cause a rated operating time of the drive motor to decrease and power and driving performance of the vehicle to deteriorate (for example, power shortage on an uphill road and sudden acceleration driving limit).

Regarding a temperature distribution of the wound rotor synchronous motor, the temperature is highest at a rotor coil portion where a heating value is larger than a cooling value. This is because a copper loss heating value increases in field current conduction due to large coil resistance.

As a result, as shown in a graph of FIG. 6 accompanied, which shows a rated characteristic of the rotor, it can be seen that as field current is larger, the copper loss heating value is larger and the rated operating time is shortened.

In particular, when field current of 15 A (ampere) or more is input, heat is not rapidly dissipated due to inferiority in the cooling value as opposed to a rapid increase of the heating value at the rotor coil portion. As a result, the rated operating time is rapidly limited.

Consequently, since the large field current of 15 A or more is used in a low-speed and high-torque (for example, slow driving on a long uphill road) and high-speed and high-power (high-speed rapid acceleration) areas of the wound rotor synchronous motor, the output limit occurs due to protection of the overtemparature of the rotor in continuous operation.

### SUMMARY

The present disclosure has been made in an effort to solve the above-described problems associated with prior art.

The present disclosure is contrived to solve the problem and the present invention has been made in an effort to provide a system and a method for controlling a wound rotor synchronous motor which configure a current command map by a dualized map which is switchable according to a purpose to selectively use the current command map according to an operating condition to increase a rated operating time of the wound rotor synchronous motor without an output limit of a motor when an overtemparature of a rotor is generated.

In one aspect, the present disclosure provides a system for controlling a wound rotor synchronous motor including: an inverter control unit including a current command map, a field current controller outputting a pulse width modulation (PWM) signal based on a rotor current command from a current command map, and a stator current controller outputting the PWM signal based on a stator current command from the current command map; and an inverter power module unit switching voltage based on a final PWM signal from the field current controller and the stator current controller to make voltage to be applied and current to be conducted to a stator and a rotor of a motor, and the current command map is dualized into a rated operation current command map and a maximum efficiency current command map which are switchable when an overtemparature of the rotor is generated.

In one embodiment, the system may further include a current map switching unit receiving a current temperature of the rotor to select and switch the current command map as the rated operation current command map or the maximum efficiency current command map.

In another aspect, the present disclosure provides a method for controlling a wound rotor synchronous motor including: first receiving a torque command T*, a motor speed w, and reference voltage Vdc depending on driver's required torque in the maximum efficiency current command map in the current command map; selecting and maintaining the maximum efficiency current command map to select a maximum efficiency current command operation point for high-efficiency control of a drive motor when a current rotor temperature is equal to or less than a rotor overtemparature protection start temperature; and switching the maximum efficiency current command operation map to a rated operation current command map for selecting a rated operation current command operation point when the current rotor temperature is more than the rotor overtemparature protection start temperature.

In one embodiment, when the maximum efficiency current command map is selected and maintained, outputting a rotor field current command i_{f}* and a stator d/q-axis current command i_{dq}* from the maximum efficiency current command map; sequentially generating a voltage command (stator v_{uvw}*) and a final PWM signal based on the stator d/q-axis current command i_{dq}* in a stator current controller while sequentially generating a voltage command (field v_{f}*) and the final PWM signal based on the rotor field current command i_{f}* in a field current controller; and outputting the final PWM signal to an inverter power module unit from the field current controller and the stator current controller may be sequentially performed.

In another embodiment, when the maximum efficiency current command map is switched to the rated operation current command map, outputting the rotor field current command i_{f}* and the stator d/q-axis current command i_{dq}* from the rated operation current command map; sequentially generating the voltage command (stator v_{uvw}*) and the final PWM signal based on the stator d/q-axis current command i_{dq}* in the stator current controller while sequentially generating the voltage command (field v_{f}*) and the final PWM signal based on the rotor field current command i_{f}* in the field current controller; and outputting the final PWM signal to the inverter power module unit from the field current controller and the stator current controller may be sequentially performed.

Further areas of applicability will become apparent from the description provided herein. It should be understood that the description and specific examples are intended for purposes of illustration only and are not intended to limit the scope of the present disclosure.

Through the aforementioned problem solving means, the present invention provides the following effects.

First, the field current can be reduced and the copper loss heating value can be decreased without the output limit of the drive motor when the overtemparature of the rotor is generated and the rated operating time of the wound rotor synchronous motor can be increased.

Second, problems (for example, driving is impossible on a long uphill road and a rapid acceleration driving limit due to the output limit when the overtemparature of the rotor is generated) which may occur due to the overtemparature of the rotor can be prevented and actual drivability (for example, responsiveness of the vehicle which can react to a driver's will and expectation).

Third, supplementation and addition of a separate hardware cooling apparatus for preventing the overtemparature of the rotor are not required to suppress a rise in manufacturing cost of a motor component.

Fourth, a durability life-span of the motor can be improved because the temperature of the rotor can be decreased as compared with the related art.

Other aspects and embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### DRAWINGS

In order that the disclosure may be well understood, there will now be described various forms thereof, given by way of example, reference being made to the accompanying drawings, in which:

FIG. 1 is a control configuration diagram of a wound rotor synchronous motor;

FIG. 2 is a control configuration diagram in which a current command map of the wound rotor synchronous motor is dualized;

FIG. 3 is a graph illustrating a displacement of a current command when an operating point of the wound rotor synchronous motor is switched from a maximum efficiency map operating point to a rated operation map operating point;

FIG. 4 is a flowchart illustrating a build-up process of dualizing a current command map for driving control of a wound rotor synchronous motor;

FIG. 5 is a flowchart illustrating a process of controlling the wound rotor synchronous motor by using the dualized current command map; and

FIG. 6 is a graph illustrating a rotor rated characteristic of the wound rotor synchronous motor.

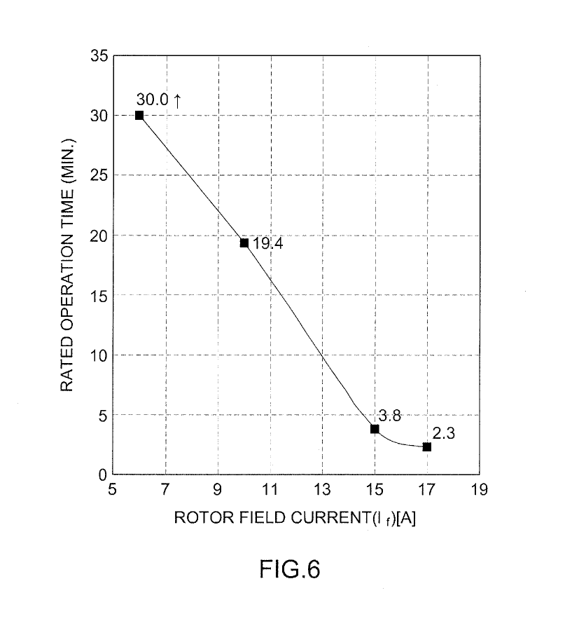

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

The drawings described herein are for illustration purposes only and are not intended to limit the scope of the present disclosure in any way.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, embodiments of the present disclosure will be described in detail with reference to the accompanying drawings.

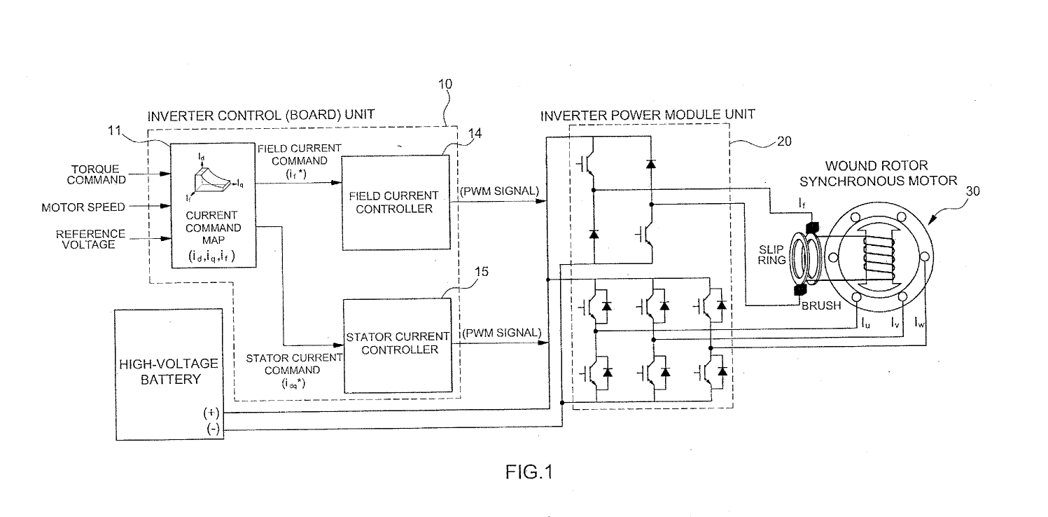

FIG. 1 is a control diagram of a wound rotor synchronous motor.

As illustrated in FIG. 1, as a control system configuration for improving rated operability considering a rotor overtemperature phenomenon of a wound rotor synchronous motor 30, an apparatus for controlling the wound rotor synchronous motor 30 includes an inverter control unit 10 and an inverter power module unit 20.

The inverter control unit 10 is configured to include a 3D current command map 11 having a torque command T*, a motor speed w, and reference voltage Vdc as inputs, a field current controller 14 outputting a PWM signal based on a rotor current command from the current command map 11, and a stator current controller 15 outputting the PWM signal based on a stator current command from the current command map 11.

In order to drive the wound rotor synchronous motor 30, first, a stator d/q-axis current command i_{dq}* and a rotor field current command i_{f}* are selected from the 3D current command map 11 having the torque command T*, the motor speed ω, and the reference voltage Vdc as the inputs.

Subsequently, a voltage command (field v_{f}*) and a final PWM signal are sequentially generated in the field current controller 14 based on the rotor field current command i_{f}* from the current command map 11 and the final PWM signal from the field current controller 14 is output to the inverter power module unit 20.

Simultaneously, a voltage command (stator v_{uvw}*) and the final PWM signal are sequentially generated in the stator current controller 15 based on the stator d/q-axis current command idq* from the current command map 11 and the final PWM signal from the stator current controller 15 is output to the inverter power module unit 20.

Accordingly, the inverter power module unit 20 switches voltage based on each PWM signal, and as a result, voltage is applied and current is conducted to a stator and a rotor of the drive motor 30, thereby outputting desired motor torque.

The current command map is dualized into a rated operation current command map which is a field current minimum operation map and a maximum efficiency current command map which is a reference current map which are switchable according to whether the overtemparature of the rotor is generated.

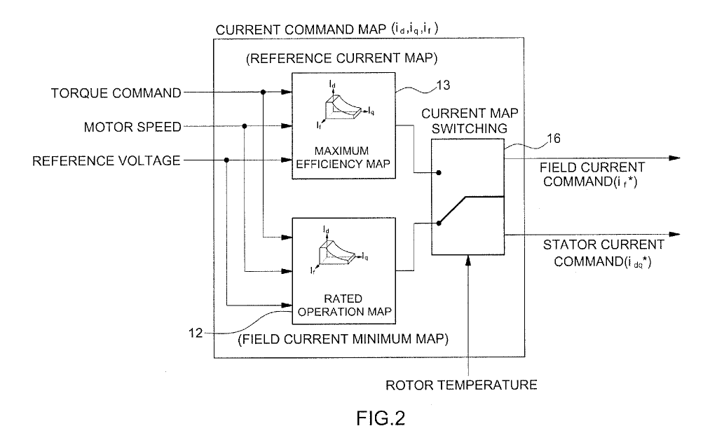

To this end, as illustrated in FIG. 2, the 3D current command map having the torque command T*, the motor speed w, and the reference voltage Vdc as the inputs is dualized into the rated operation current command map 12 which is the field current minimum operation map and the maximum efficiency current command map 13 which is the reference current map.

Further, a current map switching unit 16 is connected to output terminals of the rated operation current command map 12 and the maximum efficiency current command map 13 and the current map switching unit 16 receives a current temperature of the rotor to select and switch the current command map to one of the rated operation current command map 12 and the maximum efficiency current command map 13.

Therefore, the current map switching unit 16 basically performs a control of selecting the maximum efficiency current command map 13 for high-efficiency control of a drive motor and on the contrary, performs a control of switching the maximum efficiency current command map 13 to the rated operation current command map 12 which is the field current minimum operation map in a specific operation condition (generation of the overtemparature of the rotor).

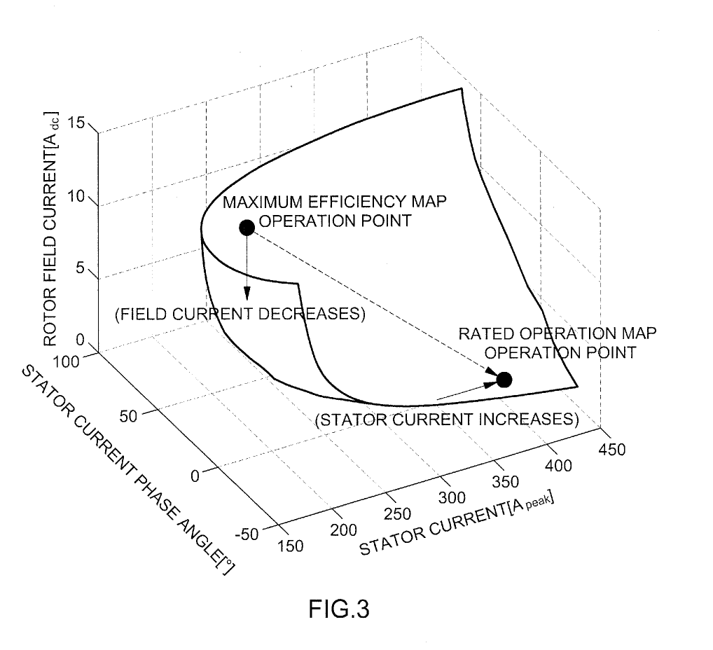

FIG. 3 is a graph illustrating a displacement of a current command when a maximum efficiency map operation point on the maximum efficiency current command map 13 is switched to a rated operation map operation point on the rated operation current command map 12 on an equivalent torque curve.

As illustrated in FIG. 3, when the maximum efficiency map operation point on the maximum efficiency current command map 13 is switched to the rated operation map operation point on the rated operation current command map 12, it can be seen that field (rotor) current decreases and stator current increases.

That is, it can be seen that a stator current increases in order to maintain the same torque (output) when a field current command decreases and in this case, motor efficiency slightly decreases.

A required output and torque of the drive motor may be maintained and the field current through reduction of a copper loss heating value may be reduced without an output limit (reduction) through switching the rated operation current command map 12 which is the field current minimum operation map when the overtemparature of the rotor is generated, and the rotor may be efficiently protected from the overtemparature.

Meanwhile, a method that dualizes the current command map into the rated operation current command map 12 which is the minimum operation map and the maximum efficiency current command map 13 which is the reference current map may be constructed by performing a motor characteristic test.

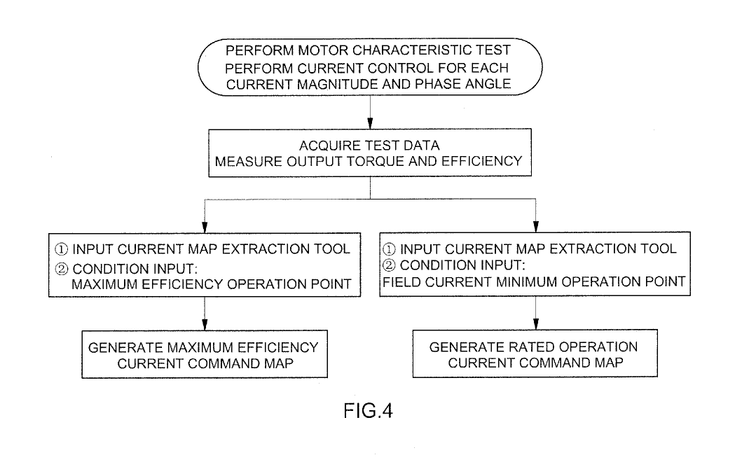

As illustrated in the flowchart of FIG. 4, the current command map may be dualized into the rated operation current command map and the maximum efficiency current command map by a process of performing the motor characteristic test such as performing a current control for each current magnitude and phase angle, a process of measuring motor output and torque through test data acquired with the test, a process of generating the maximum efficiency current command map with a condition to input the maximum efficiency operation point of the motor measured in a general current map extraction tool, and dualize the current command map into the rated operation current command map and the maximum efficiency current command map with a process of generating the measured field current minimum operation point of the motor into a general current map extraction tool.

Herein, an operation control process of the wound rotor synchronous motor using the rated operation current command map and the maximum efficiency current command map will be described below.

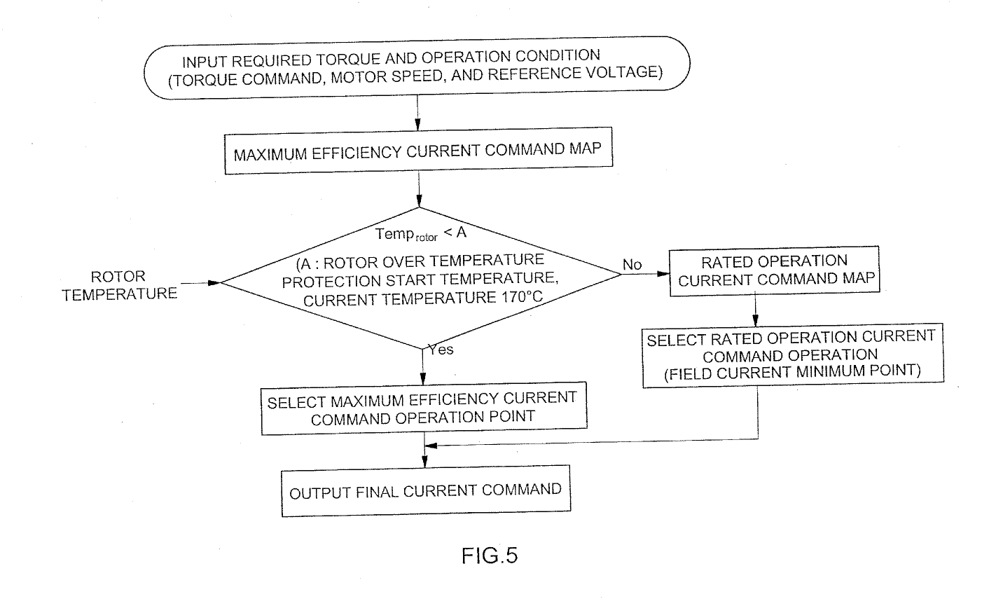

FIG. 5 is a flowchart illustrating a process of controlling the wound rotor synchronous motor by using the dualized current command map.

While the 3D current command map for controlling driving of the wound rotor synchronous motor is dualized into the rated operation current command map 12 which is the field current minimum operation map and the maximum efficiency current command map 13 which is the reference current map, the required torque and the operation control of the driver are input to the current command map.

The torque command T*, the motor speed w, and the reference voltage Vdc based on the driver's required torque are first input in the maximum efficiency current command map 13 which is the reference current map in the current command map.

In this case, when a current rotor temperature is equal to or less than an overtemparature protection start temperature, the current map switching unit 16 determines that a current operation condition is not the specific operation condition (the generation of the overtemparature of the rotor) to perform selecting and maintaining the maximum efficiency current command map 13 in order to select the maximum efficiency current command operation point for high-efficiency control of the drive motor.

Subsequently, the voltage command (field v_{f}*) and the final PWM signal are sequentially generated in the field current controller 14 based on the rotor field current command i_{f}* output from the maximum efficiency current command map 13 and the final PWM signal from the field current controller 14 is output to the inverter power module unit 20.

Simultaneously, the voltage command (stator v_{uvw}*) and the final PWM signal are sequentially generated in the stator current controller 15 based on the stator d/q-axis current command i_{dq}* output from the maximum efficiency current command map 13 and the final PWM signal from the stator current controller 15 is output to the inverter power module unit 20.

Accordingly, the inverter power module unit 20 switches voltage based on each PWM signal, and as a result, voltage and current are applied to a stator and a rotor of the drive motor 30, thereby outputting desired motor torque.

On the contrary, when the current rotor temperature is equal to or more than the rotor overtemparature protection start temperature, the current map switching unit 16 determines that the current operation condition is a specific operation condition (the generation of the overtemparature of the rotor) to perform switching of selecting the rated operation current command map 12 which is the field current minimum operation map for selecting the rated operation current command operation point.

Subsequently, the voltage command (field v_{f}*) and the final PWM signal are sequentially generated in the field current controller 14 based on the rotor field current command i_{f}* output from the rated operation current command map 12 and the final PWM signal from the field current controller 14 is output to the inverter power module unit 20.

Simultaneously, the voltage command (stator v_{uvw}*) and the final PWM signal are sequentially generated in the stator current controller 15 based on the stator d/q-axis current command i_{dq}* output from the rated operation current command map 12 and the final PWM signal from the stator current controller 15 is output to the inverter power module unit 20.

Similarly, the inverter power module unit 20 switches voltage based on each PWM signal, and as a result, voltage and current are applied to a stator and a rotor of the drive motor 30, thereby outputting desired motor torque.

As such, the current command map is switched to the maximum efficiency current command map or the rated operation current command map to protect the rotor from the overtemparature while satisfying the required output and torque of the drive motor without output limit (reduction) through the rated operation current command map when the overtemparature of the rotor is generated.

In other words, when the maximum efficiency map operation point on the maximum efficiency current command map 13 is switched to the rated operation map operation point on the rated operation current command map 12, since the stator current increases while the field (rotor) current decreases, that is, since the stator current command increases to maintain the same motor torque (output) when the field current command decreases, the rotor may be protected from the overtemparature while satisfying the required output and torque of the drive motor without output reduction through the rated operation current command map when the overtemparature of the rotor is generated.

The description of this disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for controlling a wound rotor synchronous motor, the system comprising:
an inverter control unit including
a field current controller configured to output a pulse width modulation (PWM) signal based on a rotor current command from a current command map, and
a stator current controller configured to output the PWM signal based on a stator current command from the current command map; and
an inverter power module unit configured to apply voltage and current to a stator and a rotor of the motor by switching voltage based on a final PWM signal from the field current controller and the stator current controller,
wherein the current command map is dualized into a rated operation current command map and a maximum efficiency current command map which are switchable when an overtemperature of the rotor is generated.

2. The system of claim 1, further comprising:
a current map switching unit configured to switch the current command map to the rated operation current command map or the maximum efficiency current command map in response to a receipt of a current temperature of the rotor.

3. A method for controlling a wound rotor synchronous motor, the method comprising:
receiving, at a maximum efficiency current command map in a current command map, a torque command T*, a motor speed w, and reference voltage Vdc depending on driver's required torque;
selecting and maintaining the maximum efficiency current command map to select a maximum efficiency current command operation point for high-efficiency control of a drive motor when a current rotor temperature is equal to or less than a rotor overtemperature protection start temperature; and
switching the maximum efficiency current command operation map to a rated operation current command map for selecting a rated operation current command operation point when the current rotor temperature is more than the rotor overtemperature protection start temperature.

4. The method of claim 3, wherein selecting and maintaining the maximum efficiency current command map comprising:
outputting a rotor field current command i_{f}* and a stator d/q-axis current command i_{dq}* from the maximum efficiency current command map;
sequentially generating a voltage command (stator v_{uvw}*) and a final PWM signal based on the stator d/q-axis current command i_{dq}* in a stator current controller while sequentially generating a voltage command (field v_{f}*) and the final PWM signal based on the rotor field current command i_{f}* in a field current controller; and
outputting the final PWM signal to an inverter power module unit from the field current controller and the stator current controller.

5. The method of claim 3, wherein switching the maximum efficiency current command operation map to a rated operation current command map further comprising:
outputting the rotor field current command i_{f}* and the stator d/q-axis current command i_{dq}* from the rated operation current command map;
sequentially generating the voltage command (stator v_{uvw}*) and the final PWM signal based on the stator d/q-axis current command i_{dq}* in the stator current controller while sequentially generating the voltage command (field v_{f}*) and the final PWM signal based on the rotor field current command i_{f}* in the field current controller; and
outputting the final PWM signal to the inverter power module unit from the field current controller and the stator current controller.

6. The method of claim 3, wherein when the maximum efficiency map operation point on the maximum efficiency current command map is switched to the rated operation map operation point on the rated operation current command map, stator current increases while field current decreases.
